(19) United States
(12) Patent Application Publication
(10) Pub. No.: US 2024/0258810 A1
(43) Pub. Date: Aug. 1, 2024

(54) GENERATION METHOD, GENERATION DEVICE, AND NON-TRANSITORY COMPUTER READABLE RECORDING MEDIUM

(71) Applicant: Panasonic Intellectual Property Corporation of America, Torrance, CA (US)

(72) Inventors: Junichi IMOTO, Osaka (JP); Nobuaki TASAKI, Osaka (JP)

(73) Assignee: Panasonic Intellectual Property Corporation of America, Torrance, CA (US)

(21) Appl. No.: 18/633,197

(22) Filed: Apr. 11, 2024

Related U.S. Application Data
(63) Continuation of application No. PCT/JP2022/038183, filed on Oct. 13, 2022.

(30) Foreign Application Priority Data
Oct. 13, 2021 (JP) 2021-168379

(51) Int. Cl. H02J 7/00; G06Q 50/06; H02J 50/80

(52) U.S. Cl. CPC H02J 7/0068; G06Q 50/06; H02J 7/0048; H02J 50/80

(57) ABSTRACT

A generation apparatus acquires a driving plan for an electric mobile body; generates charge and discharge plan candidates for respective batteries; excludes on the basis of the driving plan a charge and discharge plan candidate that involves charge and discharge in a non-connection period in which the electric mobile body is not connected to a power system and a charge and discharge plan candidate that does not fill a supposed battery consumption amount of the electric mobile body in the non-connection period from the charge and discharge plan candidates; calculates an operation cost of the power system for a charge and discharge plan candidate which remains after the exclusion; determines a charge and discharge plan on the basis of the operation cost; and outputs the determined charge and discharge plan.

### FIELD OF INVENTION

The present disclosure relates to a technique of generating a charge and discharge plan for a power system including a battery.

### BACKGROUND ART

Patent Literature 1 discloses a technique of estimating a degradation state of a secondary battery on the basis of use history data of the secondary battery, and calculating an evaluation price of a mobile body having the secondary battery on the basis of the estimated degradation state.

Patent Literature 2 discloses a technique of calculating first parameters on the basis of states of a plurality of batteries, setting the calculated respective first parameters for the batteries, calculating respective second parameters for the batteries on the basis of respective profits from the batteries, respective operation rates of the batteries, and respective degradation degrees of the batteries, and setting the calculated respective second parameters for the batteries.

However, the techniques described above provide no consideration to a driving plan of an electric mobile body, and thus are not sufficient to achieve optimization for an operation cost of a power system including a battery of the electric mobile body.
Patent Literature 1: Japanese Unexamined Patent Publication No. 2006-197765
Patent Literature 2: International Unexamined Patent Publication WO 2015/129032

### SUMMARY OF THE INVENTION

The present disclosure has been made to solve the above-mentioned problems, and provides a technique that enables generation of a charge and discharge plan further optimized for an operation cost of a power system including a battery of an electric mobile body.

A generation method according to an aspect of the present disclosure for generating a charge and discharge plan for a power system that is connected to a power grid and has a load and a plurality of batteries including a battery of an electric mobile body, by a computer, includes: acquiring a driving plan for the electric mobile body; generating respective charge and discharge plan candidates for the batteries; excluding on the basis of the driving plan a charge and discharge plan candidate that involves charge and discharge in a non-connection period in which the electric mobile body is not connected to the power system and a charge and discharge plan candidate that does not fill a supposed battery consumption amount of the electric mobile body in the non-connection period from the charge and discharge plan candidates; calculating an operation cost of the power system for a charge and discharge plan candidate which remains after the exclusion; determining a charge and discharge plan on the basis of the operation cost; and outputting the determined charge and discharge plan.

The present disclosure enables generation of a charge and discharge plan further optimized for an operation cost of a power system including a battery of an electric mobile body.

### BRIEF DESCRIPTION OF THE DRAWINGS

FIG. 1 is a block diagram showing an exemplary whole configuration of a generation system according to an embodiment of the present disclosure.

FIG. 2 is a block diagram showing an exemplary configuration of a generation apparatus.

FIG. 3 is a flowchart showing an exemplary process of the generation apparatus according to the embodiment of the present disclosure.

FIG. 4 is a graph showing an exemplary entire charge and discharge plan indicated by a first candidate.

FIG. 5 is a graph showing an exemplary individual charge and discharge plan indicated by a second candidate.

FIG. 6 is a graph showing an exemplary individual charge and discharge plan indicated by a third candidate for a battery of an electric mobile body.

FIG. 7 is a diagram showing a comparative example of a power system in operation.

FIG. 8 is a diagram showing a power system operated by the generation apparatus according to the embodiment of the present disclosure.

FIG. 9 is a diagram showing an exemplary operation of the power system.

### DETAILED DESCRIPTION

Underlying Findings for Present Disclosure Vehicle-to-Home (VtoH), which allows supply of power from an electric mobile body to a facility, spreads. A facility accordingly spreads that has a power system including a battery chargeable with power supplied from an electric mobile body and power generated by a solar power generator and a fuel cell.

Such a power system causes a battery to charge and discharge according to a charge and discharge plan generated in advance. The charge and discharge plan is required to be further optimized for an operation cost of the power system. The operation cost is, e.g., an asset value decrease amount due to degradation of the battery and a power purchase cost of a power grid.

In the generation of the charge and discharge plan, a driving plan of an electric mobile body has not been considered, and thus a connection period in which the electric mobile body is connected to the power system has not been recognized. Therefore, respective charge and discharge plans for batteries that eliminate dependency on power of the electric mobile body have been generated so that necessary power for the power system is ensured by a power grid and a preinstalled battery. This is not sufficient for generation of a charge and discharge plan further optimized for the operation cost.

The present disclosure has been made to solve the above-mentioned problems.

(1) A generation method according to an aspect of the present disclosure for generating a charge and discharge plan for a power system that is connected to a power grid and has a load and a plurality of batteries including a battery of an electric mobile body, by a computer, includes: acquiring a driving plan for the electric mobile body; generating respective charge and discharge plan candidates for the batteries; excluding on the basis of the driving plan a charge and discharge plan candidate that involves charge and discharge in a non-connection period in which the electric mobile body is not connected to the power system and a charge and discharge plan candidate that does not fill a supposed battery consumption amount of the electric mobile body in the non-connection period from the charge and discharge plan candidates; calculating an operation cost of the power system for a charge and discharge plan candidate which remains after the exclusion; determining a charge and discharge plan on the basis of the operation cost; and outputting the determined charge and discharge plan.

In this configuration, a driving plan of the electric mobile body is acquired, and a charge and discharge plan for each of the batteries is determined in consideration of the acquired driving plan. Thus, an individual charge and discharge plan for each of the batteries to provide the power system with necessary power can be determined in consideration of power from the electric mobile body. Thus, a charge and discharge plan further optimized for the operation cost can be generated. Further, generation of a charge and discharge plan that cannot fill a battery consumption amount necessary for the electric mobile body to run in the non-connection period can be prevented.

(2) In the generation method described in (1) above, the driving plan may cover a connection period and the non-connection period of the electric mobile body to the power system.

This configuration enables determination of a charge and discharge plan for each of the batteries in consideration of the driving plan that covers the connection period and the non-connection period.

(3) In the generation method described in (1) or (2) above, in the generation of the charge and discharge plan candidate, a plurality of first candidates being entire charge and discharge plan candidates each of which is for a charge and discharge plan for an entirety of the batteries may be generated, and a plurality of second candidates being individual charge and discharge plan candidates each of which is for a charge and discharge plan for each of the batteries and satisfies an entire charge and discharge plan may be generated for each of the first candidates, in the exclusion of the candidates, a plurality of third candidates may be extracted by excluding on the basis of the driving plan a second candidate being a charge and discharge plan candidate for a battery of the electric mobile body that involves charge and discharge in the non-connection period and a second candidate being a charge and discharge plan candidate that does not fill a supposed battery consumption amount of the battery of the electric mobile body in the non-connection period from the second candidates, in the calculation of the operation cost, an operation cost of the power system for each of the first candidates and the third candidates may be calculated, in the determination of the charge and discharge plan, an individual charge and discharge plan may be determined on the basis of the operation cost, and in the output, the individual charge and discharge plan may be output.

In this configuration, a plurality of first candidates being entire charge and discharge plan candidates is generated, a plurality of second candidates being individual charge and discharge plan candidates each of which satisfies an entire charge and discharge plan is generated for each of the first candidates, third candidates are extracted by excluding a second candidate having a charge and discharge plan that involves charge and discharge in the non-connection period and a second candidate having a charge and discharge plan that does not fill a supposed battery consumption amount of the battery of the electric mobile body in the non-connection period from the second candidates, an operation cost for each of the first candidates and the third candidates is calculated, and an individual charge and discharge plan is determined on the basis of the calculated operation cost. Thus, an efficient charge and discharge plan that is optimized for the operation cost and does not cause a failure in the process can be generated. Further, generation of an individual charge and discharge plan that cannot fill a battery consumption amount necessary for the electric mobile body to run in the non-connection period can be prevented.

(4) In the generation method described in any one of (1) to (3) above, the operation cost may cover at least one of an asset value decrease amount due to degradation of each of the batteries and a power purchase cost of the power grid.

This configuration enables generation of a charge and discharge plan further optimized for at least one of the asset value decrease amount due to degradation of each of the batteries and the power purchase cost of the power grid.

(5) In the generation method described in any one of (1) to (4) above, in the extraction of the third candidates, at least one of a second candidate having a charge and discharge plan that allows a state of charge (SOC) of the battery to be less than 0% or larger than 100% and a second candidate having a charge and discharge plan that allows an SOC of the battery of the electric mobile body to be not larger than a reference SOC at a scheduled movement start time may be further excluded from the second candidates to extract the third candidates.

In this configuration, at least one of a second candidate having a charge and discharge plan that allows an SOC of the battery to be less than 0% or larger than 100% and a second candidate having a charge and discharge plan that allows an SOC of the battery of the electric mobile body at a start of movement to be not larger than a reference SOC is excluded to extract the third candidates. Thus, generation of an individual charge and discharge plan that involves an impossible SOC of each of the batteries, and/or generation of an individual charge and discharge plan that causes the electric mobile body to be immovable due to shortage of the SOC at the scheduled movement start time can be prevented.

(6) In the generation method described in (3) above, the operation cost may cover an asset value decrease amount due to degradation of each of the batteries and a power purchase cost of the power grid, in the calculation of the operation cost, a prediction value for power at a time point of prediction may be calculated on the basis of power history information on the power system, and a power purchase cost for each of the first candidates may be calculated on the basis of the calculated prediction value, and an asset value decrease amount due to degradation of the battery associated with each of the third candidates may be calculated on the basis of the individual charge and discharge plan of each of the third candidates, in the determination of the individual charge and discharge plan, a final third candidate for each of the batteries may be determined for each of the first candidates on the basis of each of the calculated asset value decrease amounts, a sum of the power purchase cost and a total of the asset value decrease amounts for the final third candidates may be calculated for each of the first candidates, and a final first candidate may be determined among the first candidates on the basis of the sums, and a final third candidate associated with the determined final first candidate may be determined to be the individual charge and discharge plan.

In this configuration, a prediction value for power at a time point of prediction is calculated on the basis of power history information, a power purchase cost for each of the first candidates is calculated on the basis of the calculated prediction value, and an asset value decrease amount for the battery associated with each of the third candidates is calculated on the basis of the individual charge and discharge plan of each of the third candidates. Further, a final third candidate for each of the batteries is determined for each of the first candidates on the basis of each of the calculated asset value decrease amounts, and a sum of the power purchase cost and a total of the asset value decrease amounts for the final third candidates is calculated for each of the first candidates. Further, a final first candidate is determined among the first candidates on the basis of the sums, and a final third candidate associated with the determined final first candidate is determined to be the individual charge and discharge plan. Thus, an individual charge and discharge plan further optimized for the power purchase cost and the asset value decrease amounts can be generated.

(7) In the generation method described in (6) above, the prediction value may include at least one of a prediction value of consumed power, a prediction value of generated power, a prediction value of a power purchase unit price, and a prediction value of a power selling unit price in the power system, and the power history information may include at least one of a history of the consumed power, a history of the generated power, a history of the power purchase unit price, and a history of the power selling unit price.

This configuration enables calculation of at least one of a prediction value of consumed power, a prediction value of generated power, a prediction value of a power purchase unit price, and a prediction value of a power selling unit price, based on the power history information that includes at least one of a history of the consumed power, a history of the generated power, a history of the power purchase unit price, and a history of the power selling unit price. Thus, the power purchase cost for each of the first candidates can be accurately calculated.

(8) In the generation method described in (6) or (7) above, in the calculation of the power purchase cost, at least one of date-and-time information, weather information, and temperature information at the time point of prediction may be acquired as input data, and the prediction value may be calculated by inputting the input data to a trained model that has been generated by machine learning of teaching data including the power history information associated with at least one of the date-and-time information, the weather information, and the temperature information.

In this configuration, at least one of date-and-time information, weather information, and temperature information at a time point of prediction is acquired as input data, and a prediction value is calculated by inputting the input data to a trained model. Thus, the prediction value can be accurately calculated.

(9) In the generation method described in any one of (1) to (8) above, the charge and discharge plan may indicate a temporal transition of charged and discharged power in a unit period.

This configuration enables generation of an individual charge and discharge plan that indicates a temporal transition of charged and discharged power in a unit period.

(10) In the generation method described in any one of (6) to (8) above, in the determination of the final first candidate, a first candidate having the minimum sum among the first candidates may be determined as the final first candidate.

In this configuration, a first candidate having a minimum sum of the power purchase cost of the power grid and the total of the asset value decrease amounts for the final third candidates is determined as the final first candidate. Thus, an individual charge and discharge plan optimized to reduce the power purchase cost and the asset value decrease amounts can be generated.

(11) In the generation method described in any one of (1) to (10) above, the power system may include at least one of a solar power generator and a fuel cell.

This configuration enables generation of an individual charge and discharge plan in consideration of generated power by a solar power generator and a fuel cell.

(12) In the generation method described in any one of (1) to (11) above, the power system may further include respective power controllers for controlling charge and discharge of the batteries, and in the output, the charge and discharge plan may be output to each of the power controllers.

The respective individual charge and discharge plans for the batteries are output to the power controllers. Thus, the power controllers can control operation of the batteries according to the respective individual charge and discharge plans.

(13) A generation apparatus according to another aspect of the present disclosure for generating a charge and discharge plan for a power system that is connected to a power grid and has a load and a plurality of batteries including a battery of an electric mobile body, includes: an acquisition part for acquiring a driving plan for the electric mobile body; a generation part for generating respective charge and discharge plan candidates for the batteries; an extraction part for excluding on the basis of the driving plan a charge and discharge plan candidate that involves charge and discharge in a non-connection period in which the electric mobile body is not connected to the power system and a charge and discharge plan candidate that does not fill a supposed battery consumption amount of the electric mobile body in the non-connection period from the charge and discharge plan candidates; a cost calculation part for calculating an operation cost of the power system for a charge and discharge plan candidate which remains after the exclusion; a determination part for determining a charge and discharge plan on the basis of the operation cost; and an output part for outputting the determined charge and discharge plan.

This configuration enables provision of a generation apparatus that exerts the same advantageous effects as those described for the generation method.

A generation program according to another aspect of the present disclosure for causing a computer to implement a generation method for generating a charge and discharge plan for a power system that is connected to a power grid and has a load and a plurality of batteries including a battery of an electric mobile body, causes the computer to execute a process of: generating respective charge and discharge plan candidates for the batteries; excluding on the basis of the driving plan a charge and discharge plan candidate that involves charge and discharge in a non-connection period in which the electric mobile body is not connected to the power system and a charge and discharge plan candidate that does not fill a supposed battery consumption amount of the electric mobile body in the non-connection period from the charge and discharge plan candidates; calculating an operation cost of the power system for a charge and discharge plan candidate which remains after the exclusion; determining a charge and discharge plan on the basis of the operation cost; and outputting the determined charge and discharge plan.

This configuration enables provision of a generation program that exerts the same advantageous effects as those described for the generation method.

The disclosure can be realized as a generation system operated by the generation program. Additionally, it goes without saying that the program is distributable as a non-transitory computer readable storage medium like a CD-ROM, or distributable via a communication network like the Internet.

Each of the embodiments which will be described below represents a specific example of the disclosure. Numerical values, shapes, constituents, steps, and the order thereof described below are mere examples, and thus should not be construed to delimit the disclosure. Further, constituents which are not recited in the independent claims each showing the broadest concept among the constituents in the embodiments are described as selectable constituent. The respective contents are combinable with each other in all the embodiments.

### Embodiments

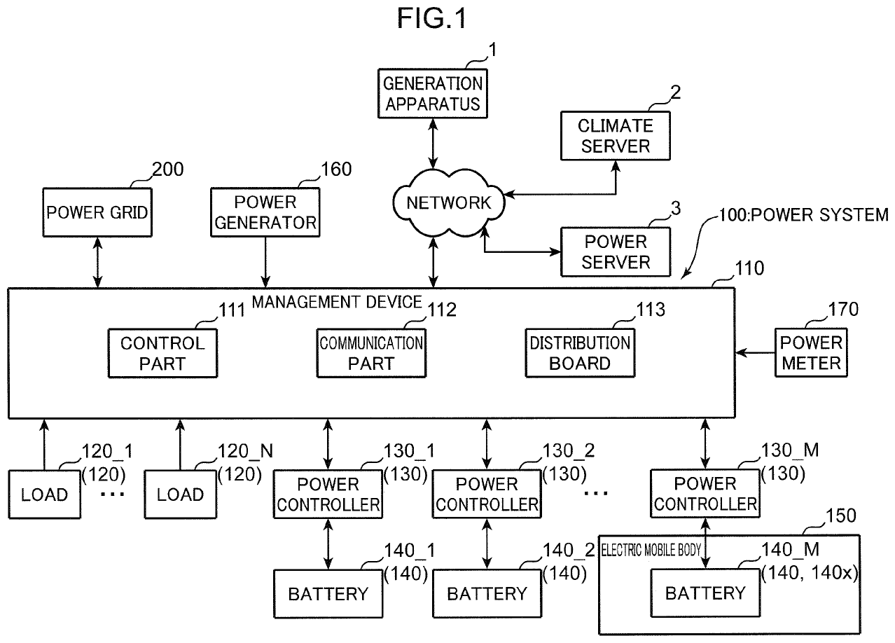

FIG. 1 is a block diagram showing an exemplary whole configuration of a generation system according to an embodiment of the present disclosure. The generation system includes a generation apparatus 1, a climate server 2, a power server 3, and a power system 100.

The generation apparatus 1 includes, e.g., a cloud server having one or more computers.

The generation apparatus 1 generates a charge and discharge plan for the power system 100.

The climate server 2 is, e.g., a cloud server having one or more computers. The climate server 2 is, e.g., a server that provides climate information. The climate information includes weather information and temperature information.

The power server 3 is, e.g., a server that is managed by a power company supplying power through the power grid 200, and provides a power purchase unit price from the power grid 200 and a power selling unit price to the power grid 200.

The power system 100 is a VtoH power system that is installed in a facility and allows connection with an electric mobile body 150. The facility is, e.g., a house, a building, an office, or a hospital.

The power system 100 includes a management device 110, N loads 120_1 to 120_N (N is an integer of one or more), M power controllers 130_1 to 130_M (M is an integer of two or more), and M batteries 140_1 to 140_M, a power generator 160, and a power meter 170.

Hereinafter, the loads 120_1 to 120_N are generally called a load 120, the power controllers 130_1 to 130_M are generally called a power controller 130, and the batteries 140_1 to 140_M are generally called a battery 140.

The load 120 is, e.g., an electric device. The electric device is, e.g., a household appliance such as a microwave oven, an air conditioner, a television, an audio device, a lighting device, and a refrigerator.

The power controllers 130_1 to 130_M correspond to the batteries 140_1 to 140_M, respectively. The power controller 130 includes, e.g., an AC-DC converter, and causes the battery 140 to charge and discharge according to an individual charge and discharge plan under control by the management device 110. For example, the power controller 130 converts direct current power from the battery 140 to alternating current power, and outputs the converted alternating current power to the load 120 and the power grid 200. Further, the power controller 130 converts alternating current power from the power grid 200 and the power generator 160 to direct current power, and charges the battery 140 with the converted direct current power.

The battery 140 is a chargeable and dischargeable secondary battery such as a lithium-ion battery and a nickel-hydrogen battery. The battery 140 is charged with, e.g., power from a battery 140 of the electric mobile body 150, power generated by the power generator 160, and power from the power grid 200. The battery 140 supplies power to the load 120. The battery 140 supplies power to the power grid 200 in power selling. A part or all of the batteries 140_1 to 140_M may be batteries of the electric mobile body 150. In the example of FIG. 1, the battery 140_M represents the battery 140 of the electric mobile body 150, but this is merely an example. Hereinafter, “140X” denotes a battery 140 of the electric mobile body 150. A battery 140 other than the battery 140X is a stationary battery installed in the facility.

The power generator 160 is, e.g., a solar power generator or a fuel cell.

The management device 110 is a device that manages power for the facility, and includes a control part 111, a communication part 112, and a distribution board 113. The control part 111 includes, e.g., a processor such as a central processing unit (CPU). For example, the control part 111 operates the power controllers 130 according to individual charge and discharge plans being respective charge and discharge plans associated with the batteries 140_1 to 140_M and transmitted from the generation apparatus 1, so as to cause the batteries 140 to charge and discharge.

For example, the control part 111 generates power history information of the power system 100. The power history information includes a history of consumed power, a history of generated power, a history of the power purchase unit price from the power grid 200, and a history of the power selling unit price. The control part 111 generates the power history information, for example, for each unit period. An appropriate value, e.g., one day, two days, three days, or one week, can be used as the unit period.

The history of consumed power is a history of power consumed by the load 120. The history of consumed power is chronological data including consumed power measured by the power meter 170 and assigned with a timestamp (date and time). The consumed power includes power consumed by the load 120.

The history of generated power is a history of power generated by the power generator 160. The history of generated power is chronological data including generated power by the power generator 160 assigned with a timestamp (date and time).

The history of the power purchase unit price is a history of a power purchase unit price in purchase from the power grid 200 by the power system 100. The power purchase unit price is defined as, for example, a fee per a unit power (e.g., one watt). The history of the power purchase unit price is, e.g., data including the power purchase unit price and a power purchase date and time in association with each other. In a case where the power purchase unit price varies, the control part 111 acquires the power purchase unit price by gaining access to the power server 3. In a case where the power purchase unit price is fixed due to a contract between the facility and the power company, the power purchase unit price takes a fixed value.

The history of the power selling unit price is a history of a power selling unit price in power selling to the power company by the power system 100. The power selling unit price is defined as, for example, a fee per the unit power. The history of the power selling unit price is, e.g., data including the power selling unit price and a power selling date and time in association with each other. In a case where the power selling unit price is fixed due to a contract between the facility and the power company, the power selling unit price takes a fixed value.

The communication part 112 is a communication circuit that connects the management device 110 to a network. The communication part 112 receives a charge and discharge plan transmitted from the generation apparatus 1. The communication part 112 transmits the power history information generated by the control part 111 to the generation apparatus 1.

The distribution board 113 distributes power supplied from the battery 140, the power generator 160, and the power grid 200 to the load 120, the battery 140, and the power grid 200.

The power meter 170 measures consumed power of the load 120 and generated power by the power generator 160.

The electric mobile body 150 is, e.g., an electric vehicle, an electric bicycle, an electric motorcycle, or an electric scooter.

The generation apparatus 1, the climate server 2, the power server 3, and the management device 110 are communicably connected with each other via the network. The network is, e.g., a wide area network including a mobile phone communication network and the Internet.

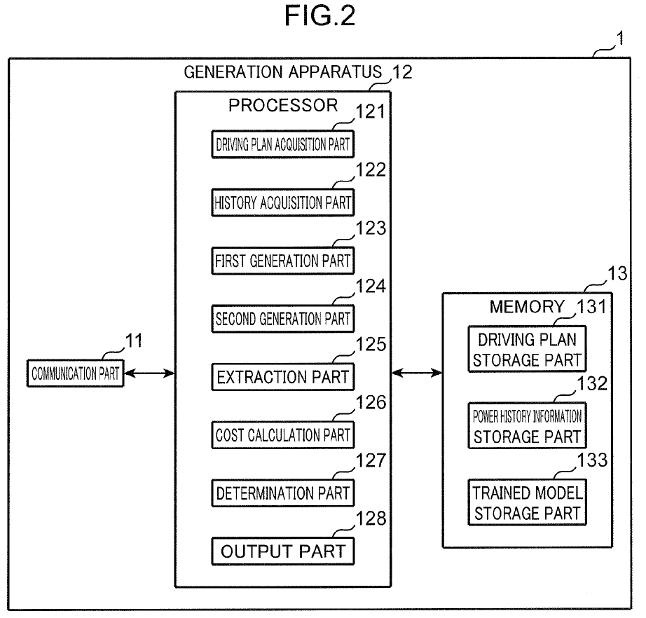

Next, the configuration of the generation apparatus 1 will be described. FIG. 2 is a block diagram showing an exemplary configuration of the generation apparatus 1. The generation apparatus 1 includes a communication part 11, a processor 12, and a memory 13.

The communication part 11 is a communication circuit that connects the generation apparatus 1 to the network. The communication part 11 receives the power history information transmitted from the management device 110, the climate information transmitted from the climate server 2, and the power purchase unit price and the power selling unit price transmitted from the power server 3. The communication part 11 transmits an individual charge and discharge plan generated by the generation apparatus 1 to the management device 110.

The processor 12 is, e.g., a CPU. The processor 12 includes a driving plan acquisition part 121, a history acquisition part 122, a first generation part 123 (an exemplary generation part), a second generation part 124 (an exemplary generation part), an extraction part 125, a cost calculation part 126, a determination part 127, and an output part 128.

The driving plan acquisition part 121, the history acquisition part 122, the first generation part 123, the second generation part 124, the extraction part 125, the cost calculation part 126, the determination part 127, and the output part 128 do performance, for example, when the processor 12 executes the generation program. However, this configuration is merely an example, and the driving plan acquisition part 121, the history acquisition part 122, the first generation part 123, the second generation part 124, the extraction part 125, the cost calculation part 126, the determination part 127, and the output part 128 may be constituted by dedicated hardware, e.g., an application specific integrated circuit (ASIC).

The driving plan acquisition part 121 acquires a driving plan for the electric mobile body 150 from the memory 13. The driving plan is information specifying a running schedule of the electric mobile body 150 in a unit period. The unit period is, e.g., one day, but is not particularly limited thereto. Specifically, the driving plan covers a connection period and a non-connection period of the electric mobile body 150 to the power system 100. The connection period is a period in which the electric mobile body 150 is electrically connected to the power controller 130 of the power system 100, i.e., a period in which the electric mobile body 150 stops. In the connection period, the battery 140X of the electric mobile body 150 is charged with power supplied from the power system 100, and supplies power to the power system 100.

The non-connection period is a period in which the electric mobile body 150 is not electrically connected to the power controller 130 of the power system 100. In the non-connection period, the electric mobile body 150 runs. In this regard, the driving plan covers a battery consumption amount of the electric mobile body 150 in the non-connection period. The connection period in the driving plan is defined by a connection start time and a connection end time. The driving plan is created by, e.g., a user of the facility, and prestored in a driving plan storage part 131 of the memory 13.

The history acquisition part 122 acquires the power history information from the power system 100 and stores it in the memory 13.

The first generation part 123 generates a plurality of first candidates being entire charge and discharge plan candidates each of which is for a charge and discharge plan for an entirety of the batteries 140. The entire charge and discharge plan is data indicative of a temporal transition of charged and discharged power for the entirety of the batteries 140 in a unit period. Hereinafter, the unit period for the entire charge and discharge plan is one day, but this is merely an example. The unit period may be two days, three days, or one week.

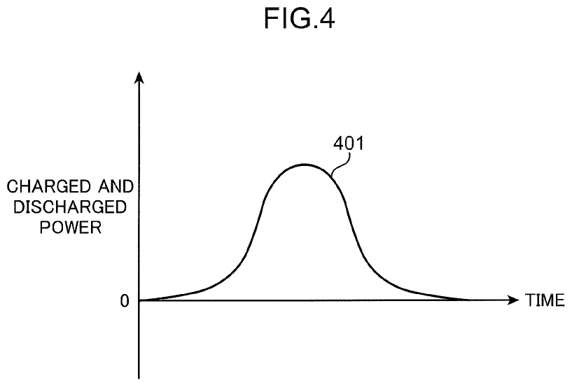

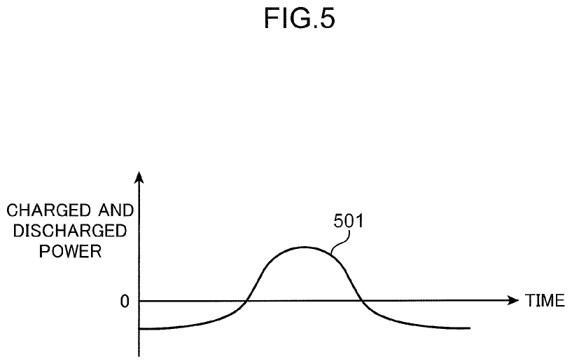

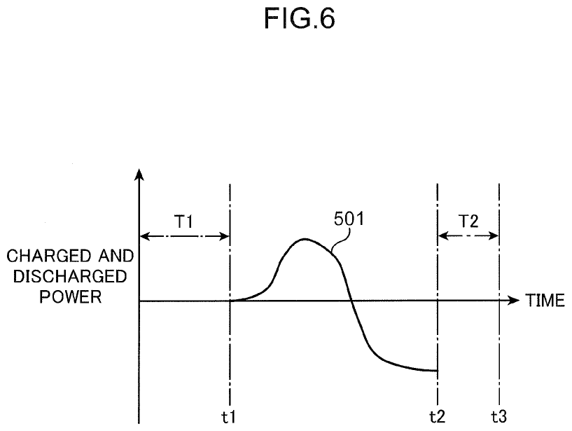

FIG. 4 is a graph showing an exemplary entire charge and discharge plan 401 indicated by a first candidate. In FIG. 4, the vertical axis represents charged and discharged power for the batteries 140, and the horizontal axis represents the time. On the vertical axis, a positive charged and discharged power represents discharged power for the batteries 140, and a negative charged and discharged power represents charged power for the batteries 140. This also applies to graphs in FIGS. 5 and 6 described later.

The entire charge and discharge plan 401 specifies, e.g., a charged and discharged power in each of a plurality of time zones obtained by dividing the unit period by a certain duration. Hereinafter, the certain duration is 30 minutes, but this is merely an example. An appropriate value, e.g., 10 minutes, 20 minutes, one hour, two hours, or three hours, can be used as the certain duration. The entire charge and discharge plan 401 has data including respective associations between charged and discharged powers and 48 (=24 hours×2) time zones; for example, a charged and discharged power in the time zone of 0:00 to 0:30 indicates “W1” and a charged and discharged power in the time zone of 0:30 to 1:00 indicates “W2”. The exemplary entire charge and discharge plan 401 in FIG. 4 is represented in the shape of a bell that is convex upward, but this is merely an example. The entire charge and discharge plan may be represented in any shape.

For example, the first generation part 123 determines a plurality of charged and discharged powers for each of the time zones by dividing a charge and discharge range between a predetermined maximum charged and discharged power and a predetermined minimum charged and discharged power by a certain number of stages, and combines sets of the determined charged and discharged powers over all the time zones to determine the plurality of first candidates. For example, in a case where there are 20 stages and 48 time zones, since there are 20 charged and discharged powers in each of the time zones, 20⁴⁸ first candidates are generated.

The second generation part 124 generates a plurality of second candidates being candidates for individual charge and discharge plans each of which is for a charge and discharge plan for each of the batteries 140 to satisfy an entire charge and discharge plan 401 indicated by each of the first candidates generated by the first generation part 123.

FIG. 5 is a graph showing an exemplary individual charge and discharge plan 501 indicated by a second candidate. The exemplary individual charge and discharge plan 501 represents charge in an early period, discharge in a middle period, and charge in a late period.

For example, the second generation part 124 generates an allocation pattern for allocating a charged and discharged power in a specific time zone of a specific first candidate to each of the batteries 140 in a certain number of stages. For example, on the assumption that a battery A and a battery B serve as the batteries 140, a charged and discharged power is allocated to the batteries in two stages, and the charged and discharged power in the specific time zone of the specific first candidate is 10, exemplary three allocation patterns or (A, B)=(10, 0), (5, 5), (0, 10) are obtained as the allocation pattern for the specific time zone. The second generation part 124 generates such allocation patterns for all of the time zones of the specific first candidate. The first value in the parentheses represents a charged and discharged power allocated to the battery A, and the second value in the parentheses represents a charged and discharged power allocated to the battery B.

The second generation part 124 generates an allocation pattern set for the unit period by combining the respective allocation patterns for all the time zones with one another, and generates a plurality of second candidates associated with the respective batteries 140 by extracting a charged and discharged power allocated to each of the batteries 140 from the generated allocation pattern set. The generated second candidates are associated with the corresponding allocation pattern set. Hereinafter, a plurality of second candidates associated with the corresponding allocation pattern set is referred to as a second candidate set.

The description will be made with a simple example. In an exemplary case where the unit period has two time zones, the charged and discharged power is allocated in two stages, and the charged and discharged power to be allocated in the first time zone is 10 and the charged and discharged power to be allocated in the second time zone is 20, three allocation patterns or (A, B)=(10, 0), (5, 5), (0, 10) are obtained in the first time zone, and three allocation patterns or (A, B)=(20, 0), (10, 10), (0, 20) are obtained in the second time zone. Then, nine (=3×3) allocation pattern sets, e.g., an allocation pattern set of (10, 0) and (20, 0) and an allocation pattern set of (10, 0) and (10, 10), are generated. Then, for example, from the allocation pattern set of (10, 0) and (20, 0), the charged and discharged power of (10, 20) allocated to the battery A is extracted to generate a second candidate for the battery A of (10, 20), and the charged and discharged power of (0, 0) allocated to the battery B is extracted to generate a second candidate for the battery B of (0, 0). The second candidate for the battery A of (10, 20) and the second candidate for the battery B of (0, 0) constitutes a second candidate set associated with the allocation pattern set of (10, 0) and (20, 0). Similarly, another second candidate set is generated for another allocation pattern set. In this regard, the first value in the parentheses in the second candidate set represents a charged and discharged power allocated in the first time zone, and the second value represents a charged and discharged power allocated in the second time zone.

In this example, the charged and discharged power is allocated in two stages for convenience of explanation, but this is merely an example; another value can be used. For example, there may be 20 stages, similarly as for the first candidates.

The extraction part 125 extracts a plurality of third candidates by excluding, on the basis of the driving plan acquired by the driving plan acquisition part 121, a second candidate being a charge and discharge plan candidate for the battery 140X of the electric mobile body 150 that involves charge and discharge in the non-connection period.

Further, the extraction part 125 acquires a battery consumption amount of the electric mobile body 150 that is supposed to be consumed in the non-connection period from the driving plan acquired by the driving plan acquisition part 121, and excludes a second candidate being a charge and discharge plan candidate for the battery 140X that does not fill the acquired battery consumption amount to thereby extract a plurality of third candidates.

FIG. 6 is a graph showing an exemplary individual charge and discharge plan 501 indicated by a third candidate for the battery 140X of the electric mobile body 150. In the example of FIG. 6, a period T1 between a time of 0 and a time t1 and a period T2 between a time t2 and a time t3 are the non-connection periods. In this regard, in the example of FIG. 6, the charged and discharged power is zero in the period T1 and the period T2, for the third candidates are extracted by excluding a second candidate for the battery 140X having a charge and discharge plan that involves charge and discharge in the non-connection period of the electric mobile body 150.

Further, third candidates are extracted by excluding a second candidate having a charge and discharge plan that allows the remaining capacity of the battery 140X at a time of start of the period T1 (time of 0) to be not larger than a battery consumption amount of the electric mobile body 150 during the period T1 that is calculated from the driving plan. Similarly, third candidates are extracted by excluding a second candidate having a charge and discharge plan that allows the remaining capacity of the battery 140X at a time of start of the period T2 (time t2) to be not larger than a battery consumption amount of the electric mobile body 150 during the period T2 that is calculated from the driving plan. This can prevent a situation where the electric mobile body 150 can no longer run according to the driving plan in the non-connection period.

Further, the extraction part 125 may generate third candidates by excluding a second candidate having a charge and discharge plan that allows a state of charge (SOC) of the battery 140 to be less than 0% or larger than 100% from the second candidates generated by the second generation part 124. Thus, a second candidate having a charge and discharge plan that allows the SOC to take an impossible value is excluded. In this regard, the extraction part 125 excludes a second candidate having at least one time zone in which the SOC becomes less than 0% or not less than 100%. The extraction part 125 calculates the remaining capacity of a battery 140 in each of the time zones from a waveform for a second candidate, and calculates the SOC for each of the time zones using the calculated remaining capacity and a full charge capacity predetermined for the battery 140. The extraction part 125 acquires the full charge capacity of the battery 140 from the memory 13.

Further, the extraction part 125 may extract third candidates by excluding a second candidate having a charge and discharge plan that allows the SOC of the battery 140X of the electric mobile body 150 to be not larger than a reference SOC at a scheduled movement start time from the second candidates generated by the second generation part 124. The scheduled movement start time is a time of start of the non-connection period of the electric mobile body 150 specified in the driving plan. The reference SOC is a predetermined SOC necessary for the electric mobile body 150 to move, and takes an appropriate value, e.g., 20%, 30%, 50%, or 60%. Thus, a second candidate having a charge and discharge plan that prevents the electric mobile body 150 from moving according to the driving plan is excluded.

A third candidate that continues from a second candidate is associated with the same corresponding allocation pattern set. A plurality of third candidates associated with the corresponding allocation pattern set is referred to as a third candidate set.

The cost calculation part 126 calculates an operation cost for each of the first candidates generated by the first generation part 123 and each of the third candidates extracted by the extraction part 125. The operation cost covers an asset value decrease amount due to degradation of each of the batteries 140 and a power purchase cost of the power grid 200.

Specifically, the cost calculation part 126 calculates a prediction value for power at a time point of prediction on the basis of the power history information stored in a power history information storage part 132, and calculates a power purchase cost for each of the first candidates on the basis of the calculated prediction value. The time point of prediction is an appropriate future time point, e.g., one day later, two days later, or one week later from the present. The prediction value includes a prediction value of consumed power, a prediction value of generated power, a prediction value of a power purchase unit price, and a prediction value of a power selling unit price in the power system 100. The details of the calculation of the power purchase cost will be described later.

The prediction value is calculated by inputting input data to a trained model that has been generated by machine learning of the power history information. The input data includes date-and-time information, the weather information, and the temperature information. The date-and-time information includes a month of the year, a date, a day of the week, and a time. The weather information indicates that it is sunny, cloudy, rainy, or snowy. The temperature information includes a temperature and a humidity. The trained model is generated as described below.

First, teaching data for a trained model is generated. The teaching data is generated by associating each of the history of the consumed power, the history of the generated power, the history of the power purchase unit price, and the history of the power selling unit price that are stored in the power history information storage part 132 with the date-and-time information, the weather information, and the temperature information. A trained model is generated by machine learning with: the date-and-time information, the weather information, and the climate information that serve as explanatory variables; and the history of the consumed power, the history of the generated power, the history of the power purchase unit price, and the history of the power selling unit price that serve as target variables. Any machine learning model that can solve a regression problem, such as a neural network and a regression model, can be used as the trained model.

The cost calculation part 126 calculates an asset value decrease amount due to degradation of the battery 140 associated with each of the third candidates on the basis of the charge and discharge plan of each of the third candidates extracted by the extraction part 125. The details of the calculation of the asset value decrease amount will be described later.

The determination part 127 determines an individual charge and discharge plan on the basis of the operation cost calculated by the cost calculation part 126. Specifically, the determination part 127 determines, for each of the first candidates, a final third candidate for each of the batteries 140 on the basis of the asset value decrease amount for each of the third candidates that is calculated as the operation cost by the cost calculation part 126, and determines the determined final third candidate to be the individual charge and discharge plan.

The determination part 127 also calculates a sum of the power purchase cost and a total of the asset value decrease amounts for the final third candidates, for each of the first candidates generated by the first generation part 123.

Further, the determination part 127 determines a final first candidate among the first candidates on the basis of the calculated sums, and determines a final third candidate associated with the determined final first candidate to be the individual charge and discharge plan.

The output part 128 outputs the individual charge and discharge plan determined by the determination part 127. Specifically, the output part 128 transmits the individual charge and discharge plan to the management device 110 through the communication part 11.

The memory 13 includes a storage device that is non-volatile and rewritable, e.g., a solid state disk drive or a hard disk drive. The memory 13 includes the driving plan storage part 131, the power history information storage part 132, and a trained model storage part 133.

The driving plan storage part 131 stores the driving plan for the electric mobile body 150. The power history information storage part 132 stores the power history information acquired by the history acquisition part 122.

The trained model storage part 133 stores the trained model used by the cost calculation part 126 for the calculation of the prediction value. The trained model storage part 133 stores a default trained model that is shared by power systems 100 managed by the generation apparatus 1, and the trained model storage part 133 may periodically update the trained model by use of power history information of each of the power systems 100 to store respective trained models customized for the power systems 100.

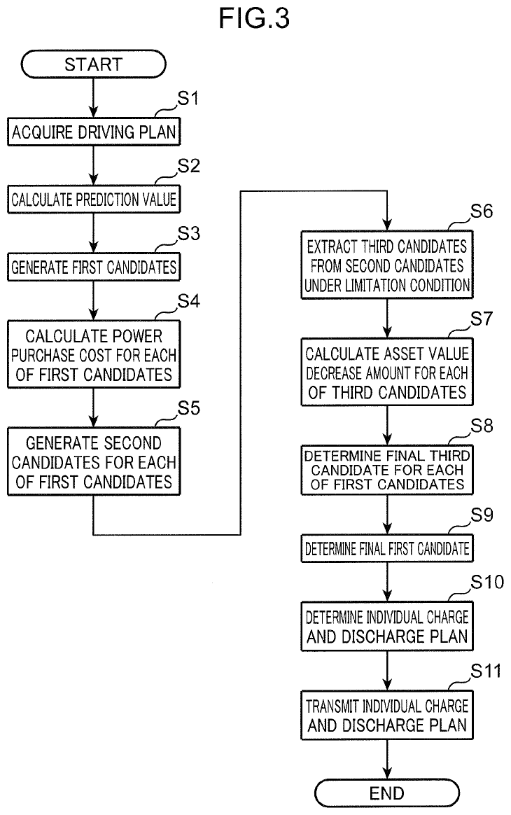

The configuration of the generation apparatus 1 is as described above. Next, a process of the generation apparatus 1 will be described. FIG. 3 is a flowchart showing an exemplary process of the generation apparatus 1 according to the embodiment of the present disclosure.

### Step S1

The driving plan acquisition part 121 acquires a driving plan for an electric mobile body 150 from the memory 13. In a case where the power system 100 allows connections with a plurality of electric mobile bodies 150, respective driving plans of the electric mobile bodies 150 are acquired.

### Step S2

The cost calculation part 126 acquires input data (date-and-time information, weather information, and temperature information) at a time point of prediction, and calculates a prediction value of consumed power, a prediction value of generated power, a prediction value of the power purchase unit price, and a prediction value of the power selling unit price by inputting the acquired input data to the trained model stored in the trained model storage part 133. The prediction values are calculated for each of the 48 time zones obtained by dividing 24 hours by 30 minutes as described above.

### Step S3

The first generation part 123 generates a plurality of first candidates being entire charge and discharge plan candidates by the method described above.

### Step S4

The cost calculation part 126 calculates a power purchase cost of the power grid 200 for each of the first candidates generated in Step S3.

The power purchase cost is calculated by the equation (1).

Power Purchase Cost=Base Fee+Σ(Power Purchase Unit Price×Power Purchase Amount-Power Selling Unit Price×Power Selling Amount) (1)

“Base Fee” refers to a value for a base fee in a unit period (one day) that is predetermined under the contract between the facility and the power company. “Power Purchase Unit Price” represents an input prediction value of a power purchase unit price in each of the time zones that is calculated in Step S2. “Power Selling Unit Price” represents an input prediction value of a power selling unit price in each of the time zones that is calculated in Step S2. “Σ” indicates summation of “Power Purchase Unit Price×Power Purchase Amount-Power Selling Unit Price×Power Selling Amount” calculated for each of the time zones over the unit period.

“Power Purchase Amount” is indicated by a positive “W” in the equation (2), and “Power Selling Amount” is indicated by a negative “W” in the equation (2).

W=Consumed Power-(Generated Power+Discharged Power) (2)

“Consumed Power” refers to a prediction value of a consumed power in a specific time zone that is calculated in Step S2. “Generated Power” refers to a prediction value of a generated power in the specific time zone that is calculated in Step S2. “Discharged Power” refers to a discharged power in the specific time zone for the specific first candidate.

### Step S5

The second generation part 124 generates a plurality of second candidates by the method described above. Thus, a plurality of second candidates satisfying an entire charge and discharge plan indicated by each of the first candidates is generated.

### Step S6

The extraction part 125 extracts third candidates by excluding a second candidate that does not satisfy a limitation condition from the second candidates generated in Step S5. As described above, the limitation condition includes a condition that a second candidate being a charge and discharge plan candidate for the battery 140X of the electric mobile body 150 that involves charge and discharge in the non-connection period is excluded, a condition that a second candidate being a charge and discharge plan candidate for the battery 140X of the electric mobile body 150 that does not fill a supposed battery consumption amount of the electric mobile body 150 in the non-connection period is excluded, a condition that a second candidate having a charge and discharge plan that allows an SOC to be less than 0% or larger than 100% is excluded, and a condition that a second candidate having a charge and discharge plan that allows the SOC of the battery 140X of the electric mobile body 150 to be not larger than a reference SOC at a scheduled movement start time is excluded.

### Step S7

The cost calculation part 126 calculates an asset value decrease amount for each of the third candidates determined in Step S6. The asset value decrease amount is represented by the equation (3).

Asset Value Decrease Amount=Battery Purchase Price×(Degradation Value/Allowable Degradation Range) (3)

“Battery Purchase Price” refers to a purchase price of a battery 140, and each purchase price for the battery 140 is prestored in the memory 13. “Degradation Value” indicates a degree of degradation of a battery 140, and is represented by, e.g., a state of health (SOH). Thus, the degradation value gets smaller as the battery 140 degrades.

The degradation value is determined on the basis of respective lengths of a charge period, a discharge period, and a standby period that involves neither charge nor discharge. In this regard, the cost calculation part 126 specifies a charge period, a discharge period, and a standby period from a waveform representing a specific third candidate, calculates a decrease amount of the degradation value on the basis of the specified charge period, discharge period, and standby period, and reduces the current degradation value of the battery 140 associated with the specific third candidate by the calculated decrease amount to thereby calculate the latest degradation value.

“Allowable Degradation Range” refers to a range between a minimum value of the degradation value and a maximum value of the degradation value. The minimum value is a predetermined degradation value indicating that a battery 140 is dead. For example, in a case where the degradation value is represented by the SOH and the minimum value is 60%, the maximum value of the degradation value is 100% and the allowable degradation range is 40 (=100-60). Thus, the asset value decrease amount increases as the degradation value increases.

### Step S8

The determination part 127 determines, for each of the first candidates, a final third candidate for each of the batteries 140 on the basis of the asset value decrease amount for each of the third candidates. Specifically, the determination part 127 specifies a third candidate set having a minimum total of the asset value decrease amounts among third candidate sets for a specific first candidate, and determines the third candidates included in the specified third candidate set as the final third candidates.

For example, in a case where the batteries 140 are a battery A and a battery B and there are third candidate sets J1, J2; the third candidate set J1 has a third candidate J1_A for the battery A and a third candidate J1_B for the battery B; and the third candidate set J2 has a third candidate J2_A for the battery A and a third candidate J2_B for the battery B, a total of the asset value decrease amounts for the third candidate set J1 is a sum of an asset value decrease amount for the third candidate J1_A and an asset value decrease amount for the third candidate J1_B. Similarly, the asset value decrease amount for the third candidate set J2 is a sum of an asset value decrease amount for the third candidate J2_A and an asset value decrease amount for the third candidate J2_B. When the total of the asset value decrease amounts for the third candidate set J1 is smaller than the total of the asset value decrease amounts for the third candidate set J2, the third candidates J1_A and J1_B, included in the third candidate set J1, are determined as the final third candidates.

### Step S9

The determination part 127 calculates a sum for each of the first candidates of: the power purchase cost calculated in Step S4; and a total of the asset value decrease amounts for the final third candidates associated with each of the first candidates, and determines a first candidate having the minimum sum obtained from the calculation as the final first candidate. A lower power purchase cost is desirable, and a smaller asset value decrease amount is desirable. Thus, a smaller sum represents smaller degradation of the batteries 140 and a lower power purchase cost, resulting in a reduced operation cost.

### Step S10

The determination part 127 determines respective final third candidates for the batteries 140 associated with the final first candidate determined in Step S9 to be respective individual charge and discharge plans for the batteries 140.

### Step S11

The output part 128 transmits the individual charge and discharge plans determined in Step S10 to the management device 110.

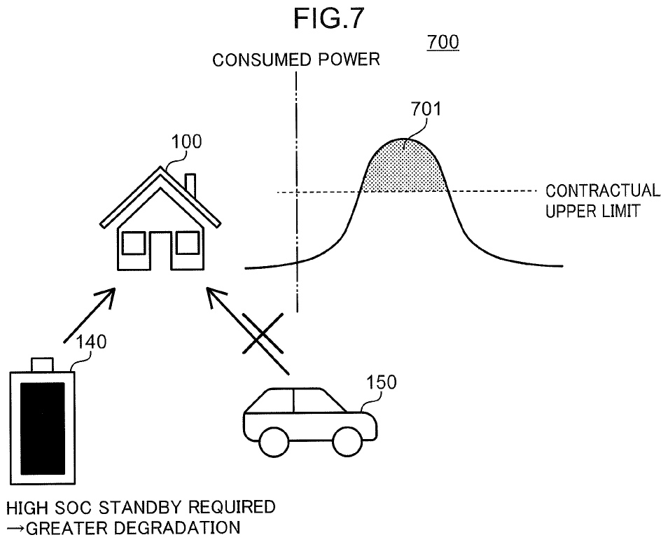

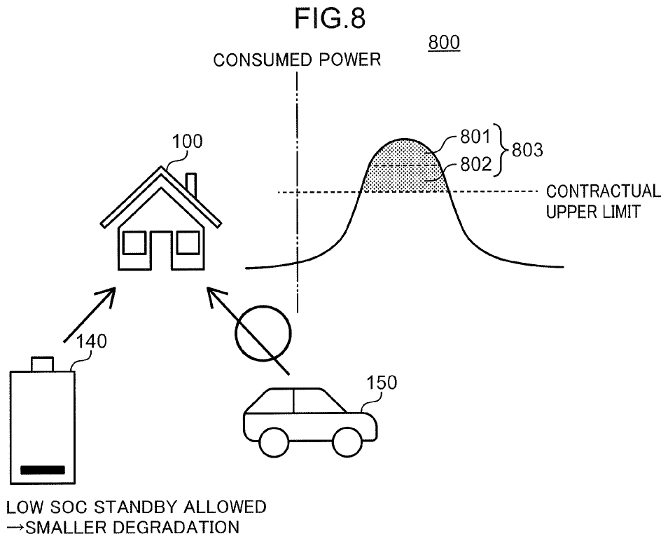

FIG. 7 is a diagram showing a comparative example of a power system 100 in operation. FIG. 8 is a diagram showing the power system 100 operated by the generation apparatus 1 according to the embodiment of the present disclosure.

The graph 700 in FIG. 7 shows a temporal transition of consumed power of the power system 100. In the comparative example, an individual charge and discharge plan for a battery 140 is generated without consideration of power of the battery 140X of the electric mobile body 150. Therefore, the individual charge and discharge plan is generated so that a whole consumed power 701 beyond a contractual upper limit indicative of available power under the contract is covered by power of the batteries 140, which requires the battery 140 to stand by at a high SOC, leading to a problem of greater degradation.

In contrast, in the embodiment, as shown in FIG. 8, an individual charge and discharge plan for a battery 140 is generated in consideration of power of the battery 140X of the electric mobile body 150. Therefore, a consumed power 803 beyond a contractual upper limit in the graph 800 indicative of a temporal transition of the consumed power in the power system 100 can be covered by power 802 of the battery 140X of the electric mobile body 150 in addition to power 801 of the batteries 140. This enables a battery 140 to stand by at a lower SOC than that in the comparative example. Consequently, the degradation of the battery 140 can be reduced.

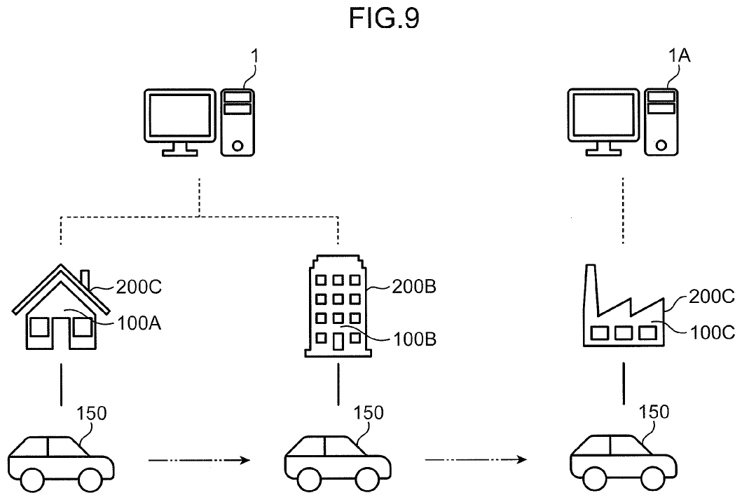

FIG. 9 is a diagram showing an exemplary operation of the power system 100. The generation apparatus 1 collectively manages a power system 100A of a facility 200A and a power system 100B of a facility 200B. This example shows that the electric mobile body 150 moves away from the facility 200A to arrive at the facility 200B, stays at the facility 200B for a while, and thereafter moves to a facility 200C and stays at the facility 200C for a while.

In this example, the electric mobile body 150 is disconnected from the power system 100A, and the electric mobile body 150 can supply power to the power system 100B when the electric mobile body 150 is connected with the power system 100B. Accordingly, the generation apparatus 1 generates an individual charge and discharge plan for a battery 140 in the power system 100B using a driving plan that covers not only a connection period and a non-connection period for the power system 100A but also a connection period and a non-connection period for the power system 100B. Thus, the power of the electric mobile body 150 is effectively used, which enables an efficient operation of the power system 100A and the power system 100B.

Since a power system 100C of the facility 200C is not connected with the generation apparatus 1, the generation apparatus 1 cannot recognize a connection period and a non-connection period of the electric mobile body 150 for the power system 100C. However, the power system 100C is connected with a generation apparatus 1A different from the generation apparatus 1. The generation apparatus 1A generates an individual charge and discharge plan for a battery 140 in the power system 100C using a driving plan that covers the connection period and the non-connection period for the power system 100C. Thus, the power of the electric mobile body 150 is effectively used, which enables an efficient operation of the power system 100C.

As described above, in the embodiment, a driving plan for the electric mobile body 150 is acquired, and an individual charge and discharge plan for each of the batteries is determined in consideration of the acquired driving plan. Thus, an individual charge and discharge plan for each of the batteries to provide the power system 100 with necessary power can be determined in consideration of power of the battery 140X of the electric mobile body 150. This allows the power of the battery 140X of the electric mobile body 150 to cover the necessary power. Therefore, power of the power grid purchased from the power company is reduced, and thus the power purchase cost can be reduced. Additionally, since necessary power beyond the contractual upper limit determined under the contract with the power company can be covered by the power of the battery 140X of the electric mobile body 150, an amount of power to be charged in a battery 140 can be reduced in comparison with the case where the whole necessary power beyond the contractual upper limit is covered by the batteries 140. This eliminates necessity of keeping a battery 140 stand by at a high SOC, enabling suppression of the degradation of the battery 140.

In the present disclosure, the following modifications may be implemented.

(1) The operation cost covers the asset value decrease amounts and the power purchase cost, but the present disclosure is not limited to this; the operation cost may cover the asset value decrease amounts only.

In this configuration, in Step S4 in FIG. 3, the first generation part 123 calculates an asset value decrease amount instead of the power purchase cost for each of the first candidates; further, in Step S9 in FIG. 4, the determination part 127 determines a first candidate having a minimum sum of the asset value decrease amount calculated in Step S4 and a total of the asset value decrease amounts for the final third candidates as the final first candidate.

(2) The operation cost covers the asset value decrease amounts and the power purchase cost, but the present disclosure is not limited to this; the operation cost may cover the power purchase cost only.

In this configuration, in Step S7 in FIG. 3, the cost calculation part 126 calculates a power purchase cost for each of the third candidates determined in Step S6; further, in Step S8 in FIG. 3, the determination part 127 determines a final third candidate for each of the batteries 140 for each of the first candidates on the basis of the power purchase cost for each of the third candidates. Specifically, the determination part 127 specifies a third candidate set having a minimum sum of the power purchase costs among third candidate sets for a specific first candidate, and determines the third candidates included in the specified third candidate set as the final third candidates; further, in Step S9 in FIG. 3, the determination part 127 determines a first candidate having a minimum sum of the power purchase cost calculated in Step S4 and the total of the power purchase costs for the final third candidates as the final first candidate.

(3) In the present disclosure, all of the batteries 140 may be batteries 140X of the electric mobile body 150.

(4) The generation apparatus 1 may be provided in the management device 110, or installed in the facility.

(5) The generation apparatus 1 may generate individual charge and discharge plans for each of a plurality of power systems 100 independent from each other, not only for one power system 100.

(6) In Step S9, the determination part 127 may calculate a weighted sum of the power purchase cost calculated in Step S4 and a total of the asset value decrease amounts for the final third candidates associated with each of the first candidates. For reducing an electricity bill for next month, for example, a weight to the power purchase cost is set to be higher than a weight to the total of the asset values decrease amounts for the final third candidates associated with each of the first candidates.

(7) In the embodiment, the second generation part 124 generates the individual charge and discharge plan candidate satisfying the entire charge and discharge plan indicated by each of the first candidates, but this is merely an example. A plurality of individual charge and discharge plan candidates (exemplary charge and discharge plan candidates) for each of the batteries 140 satisfying a predetermined entire charge and discharge plan may be generated. This configuration enables omission of the first generation part 123.

Further, in this configuration, the extraction part 125 narrows down the individual charge and discharge plan candidates by excluding an individual charge and discharge plan candidate that involves charge and discharge in the non-connection period in which the electric mobile body 150 is not connected to the power system 100 and an individual charge and discharge plan candidate that does not fill a supposed battery consumption amount of the electric mobile body 150 in the non-connection period from the charge and discharge plan candidates.

Further, in this configuration, the cost calculation part 126 calculates an operation cost for each of the narrowed-down individual charge and discharge plan candidates. For example, the cost calculation part 126 calculates an asset value decrease amount due to degradation of a battery 140 for each of the narrowed-down individual charge and discharge plan candidates.

Further, in this configuration, the determination part 127 determines an individual charge and discharge plan candidate having a minimum asset value decrease amount for each of the batteries 140 among the narrowed-down individual charge and discharge plan candidates.

Further, in this configuration, the output part 128 transmits the determined individual charge and discharge plan for each of the batteries 140 to the management device 110 through the communication part 11.

### INDUSTRIAL APPLICABILITY

The present disclosure is useful in the technical field of the VtoH that is expected to further spread.

1. A generation method for generating a charge and discharge plan for a power system that is connected to a power grid and has a load and a plurality of batteries including a battery of an electric mobile body, by a computer, comprising:
acquiring a driving plan for the electric mobile body;
generating respective charge and discharge plan candidates for the batteries;
excluding on the basis of the driving plan a charge and discharge plan candidate that involves charge and discharge in a non-connection period in which the electric mobile body is not connected to the power system and a charge and discharge plan candidate that does not fill a supposed battery consumption amount of the electric mobile body in the non-connection period from the charge and discharge plan candidates;
calculating an operation cost of the power system for a charge and discharge plan candidate which remains after the exclusion;
determining a charge and discharge plan on the basis of the operation cost; and
outputting the determined charge and discharge plan.

2. The generation method according to claim 1, wherein the driving plan covers a connection period and the non-connection period of the electric mobile body to the power system.

3. The generation method according to claim 1, wherein
in the generation of the charge and discharge plan candidate,
a plurality of first candidates being entire charge and discharge plan candidates each of which is for a charge and discharge plan for an entirety of the batteries is generated, and
a plurality of second candidates being individual charge and discharge plan candidates each of which is for a charge and discharge plan for each of the batteries and satisfies an entire charge and discharge plan is generated for each of the first candidates,
in the exclusion of the charge and discharge plan candidates,
a plurality of third candidates is extracted by excluding on the basis of the driving plan a second candidate being a charge and discharge plan candidate for a battery of the electric mobile body that involves charge and discharge in the non-connection period and a second candidate being a charge and discharge plan candidate that does not fill a supposed battery consumption amount of the battery of the electric mobile body in the non-connection period from the second candidates,
in the calculation of the operation cost, an operation cost of the power system for each of the first candidates and the third candidates is calculated,
in the determination of the charge and discharge plan, an individual charge and discharge plan is determined on the basis of the operation cost, and
in the output, the individual charge and discharge plan is output.

4. The generation method according to claim 1, wherein the operation cost covers at least one of an asset value decrease amount due to degradation of each of the batteries and a power purchase cost of the power grid.

5. The generation method according to claim 3, wherein, in the extraction of the third candidates, at least one of a second candidate having a charge and discharge plan that allows a state of charge (SOC) of the battery to be less than 0% or larger than 100% and a second candidate having a charge and discharge plan that allows an SOC of the battery of the electric mobile body to be not larger than a reference SOC at a scheduled movement start time is further excluded from the second candidates to extract the third candidates.

6. The generation method according to claim 3, wherein
the operation cost covers an asset value decrease amount due to degradation of each of the batteries and a power purchase cost of the power grid,
in the calculation of the operation cost,
a prediction value for power at a time point of prediction is calculated on the basis of power history information on the power system, and a power purchase cost for each of the first candidates is calculated on the basis of the calculated prediction value, and
an asset value decrease amount due to degradation of the battery associated with each of the third candidates is calculated on the basis of the individual charge and discharge plan of each of the third candidates,
in the determination of the individual charge and discharge plan,
a final third candidate for each of the batteries is determined for each of the first candidates on the basis of each of the calculated asset value decrease amounts,
a sum of the power purchase cost and a total of the asset value decrease amounts for the final third candidates is calculated for each of the first candidates, and
a final first candidate is determined among the first candidates on the basis of the sums, and a final third candidate associated with the determined final first candidate is determined to be the individual charge and discharge plan.

7. The generation method according to claim 6, wherein
the prediction value includes at least one of a prediction value of consumed power, a prediction value of generated power, a prediction value of a power purchase unit price, and a prediction value of a power selling unit price in the power system, and
the power history information includes at least one of a history of the consumed power, a history of the generated power, a history of the power purchase unit price, and a history of the power selling unit price.

8. The generation method according to claim 6, wherein
in the calculation of the power purchase cost, at least one of date-and-time information, weather information, and temperature information at the time point of prediction is acquired as input data, and
the prediction value is calculated by inputting the input data to a trained model that has been generated by machine learning of teaching data including the power history information associated with at least one of the date-and-time information, the weather information, and the temperature information.

9. The generation method according to claim 1, wherein the charge and discharge plan indicates a temporal transition of charged and discharged power in a unit period.

10. The generation method according to claim 6, wherein
in the determination of the final first candidate, a first candidate having the minimum sum among the first candidates is determined as the final first candidate.

11. The generation method according to claim 1, wherein the power system includes at least one of a solar power generator and a fuel cell.

12. The generation method according to claim 1, wherein
the power system further includes respective power controllers for controlling charge and discharge of the batteries, and
in the output, the charge and discharge plan is output to each of the power controllers.

13. A generation apparatus for generating a charge and discharge plan for a power system that is connected to a power grid and has a load and a plurality of batteries including a battery of an electric mobile body, comprising:
an acquisition part for acquiring a driving plan for the electric mobile body;
a generation part for generating respective charge and discharge plan candidates for the batteries;
an extraction part for excluding on the basis of the driving plan a charge and discharge plan candidate that involves charge and discharge in a non-connection period in which the electric mobile body is not connected to the power system and a charge and discharge plan candidate that does not fill a supposed battery consumption amount of the electric mobile body in the non-connection period from the charge and discharge plan candidates;
a cost calculation part for calculating an operation cost of the power system for a charge and discharge plan candidate which remains after the exclusion;
a determination part for determining a charge and discharge plan on the basis of the operation cost; and
an output part for outputting the determined charge and discharge plan.

14. A non-transitory computer readable recording medium storing a generation program for causing a computer to implement a generation method for generating a charge and discharge plan for a power system that is connected to a power grid and has a load and a plurality of batteries including a battery of an electric mobile body, the generation program causing the computer to execute a process of:
acquiring a driving plan for the electric mobile body;
generating respective charge and discharge plan candidates for the batteries;
excluding on the basis of the driving plan a charge and discharge plan candidate that involves charge and discharge in a non-connection period in which the electric mobile body is not connected to the power system and a charge and discharge plan candidate that does not fill a supposed battery consumption amount of the electric mobile body in the non-connection period from the charge and discharge plan candidates;
calculating an operation cost of the power system for a charge and discharge plan candidate which remains after the exclusion;
determining a charge and discharge plan on the basis of the operation cost; and
outputting the determined charge and discharge plan.
